(19) United States
(12) Patent Application Publication
(10) Pub. No.: US 2025/0353192 A1
(43) Pub. Date: Nov. 20, 2025

(54) APPARATUSES, SYSTEMS, AND METHODS FOR MANIPULATING PANELS

(71) Applicant: The Boeing Company, Arlington, VA (US)

(72) Inventor: Chester J. Hill, Grafton, IL (US)

(73) Assignee: The Boeing Company, Arlington, VA (US)

(21) Appl. No.: 18/667,190

(22) Filed: May 17, 2024

(51) Int. Cl. B25J 15/06; B25J 5/00; B25J 19/00; B64F 5/50

(52) U.S. Cl. CPC B25J 15/0616; B25J 5/007; B25J 19/0004; B25J 19/002; B64F 5/50

(57) ABSTRACT

A system for manipulating a panel includes a supporting frame, an orienting frame, and a plurality of grippers. The orienting frame is coupled to the supporting frame and is movable in six degrees of freedom relative to the supporting frame. The grippers are coupled to the orienting frame and are configured to be releasably coupled to the panel.

### FIELD

The present disclosure relates generally to material handling and, more particularly, to apparatuses, systems, and methods for manipulating panel structures.

### BACKGROUND

Determinant assembly is often used in aircraft manufacturing and is a process that uses robotic assembly and digital manufacturing technology to improve quality, speed, and cost. Determinate assembly moves drilling of holes through components that are positioned against each other to the component fabrication process, where it is more controlled and efficient. During assembly, manufacturing teams align pre-drilled holes, place fasteners, and complete builds much faster. However, properly aligning components to their underlying substructure can be challenging, especially for large or asymmetric components, such as aircraft skin panels. Accordingly, those skilled in the art continue with research and development efforts in panel manipulation during determinate assembly.

### SUMMARY

Disclosed are examples of an apparatus, a system, and a method for manipulating a panel. The following is a non-exhaustive list of examples, which may or may not be claimed, of the subject matter according to the present disclosure.

In an example, the disclosed apparatus includes a supporting frame, an orienting frame, and a plurality of grippers. The orienting frame is coupled to the supporting frame and movable in six degrees of freedom relative to the supporting frame. The grippers are coupled to the orienting frame.

In an example, the disclosed system includes a mobile platform, a supporting frame, a linear displacement joint, an orienting frame, and a plurality of grippers. The supporting frame is coupled to the mobile platform. The linear displacement joint is coupled to the supporting frame. The angular displacement joint is coupled to the linear displacement joint. The orienting frame is coupled to the angular displacement joint 124. The grippers are coupled to the orienting frame. The linear displacement joint enables translation of the orienting frame relative to the supporting frame along an X-axis, a Y-axis, and a Z-axis. The angular displacement joint enables rotation of the orienting frame relative to the supporting frame about the X-axis, the Y-axis, and the Z-axis.

In an example, the disclosed method includes steps of: (1) at a first location, gripping the panel with a plurality of grippers; (2) supporting the panel with an orienting frame coupled to the grippers and a supporting frame coupled to the orienting frame; (3) moving the panel from the first location to a second location with a mobile platform coupled to the supporting frame; (4) selectively adjusting a linear position of the panel relative to a structure by selectively translating the orienting frame relative to the supporting frame along at least one of an X-axis, a Y-axis, and a Z-axis and selectively inhibiting translation of the orienting frame relative to the supporting frame along the X-axis, the Y-axis, and the Z-axis; and (5) selectively adjusting an angular position of the panel relative to the structure by selectively rotating the orienting frame relative to the supporting frame about at least one of the X-axis, the Y-axis, and the Z-axis and selectively inhibiting rotation of the orienting frame relative to the supporting frame along the Y-axis and the Z-axis.

Other examples of the apparatus, the system, and the method will become apparent from the following detailed description, the accompanying drawings, and the appended claims.

### BRIEF DESCRIPTION OF THE DRAWINGS

FIG. 1 is a schematic block diagram of a panel manipulation system;

FIG. 2 is a flow diagram of an example of a panel manipulation method;

FIG. 3 is a schematic, rear perspective view of an example of the system;

FIG. 4 is a schematic, front perspective view of an example of the system;

FIG. 5 is a schematic, rear perspective view of an example of a linear displacement joint of the system;

FIG. 6 is a schematic, front perspective view of an example an angular displacement joint of the system;

FIG. 7 is a schematic, perspective view of an example of a portion of the linear displacement joint and the angular displacement joint;

FIG. 8 is a schematic, perspective view of an example of the angular displacement joint and an angular brake assembly;

FIG. 9 is a schematic, side sectional view in the XZ-plane of an example of the linear displacement joint and the angular displacement joint;

FIG. 10 is a schematic, plan sectional view in the XY-plane of an example of the linear displacement joint and the angular displacement joint;

FIG. 11 is a schematic illustration of an example of a manufacturing environment;

FIG. 12 is a schematic illustration of an example of the manufacturing environment;

FIG. 13 is a flow diagram of an example of an aircraft manufacturing and service method; and

FIG. 14 is a schematic block diagram of an example of an aircraft.

### DETAILED DESCRIPTION

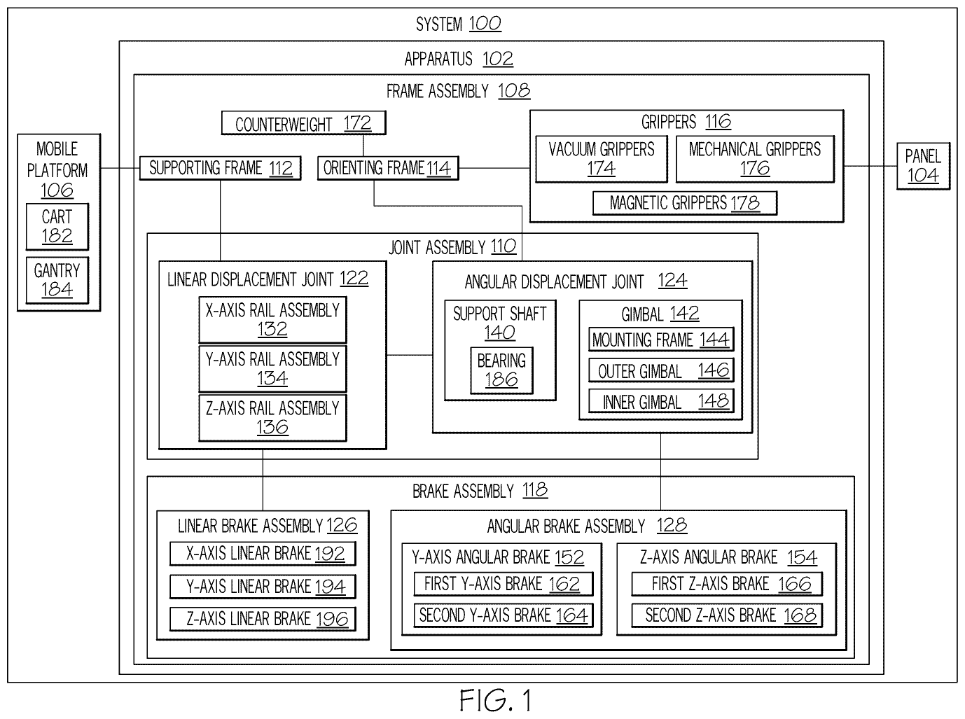

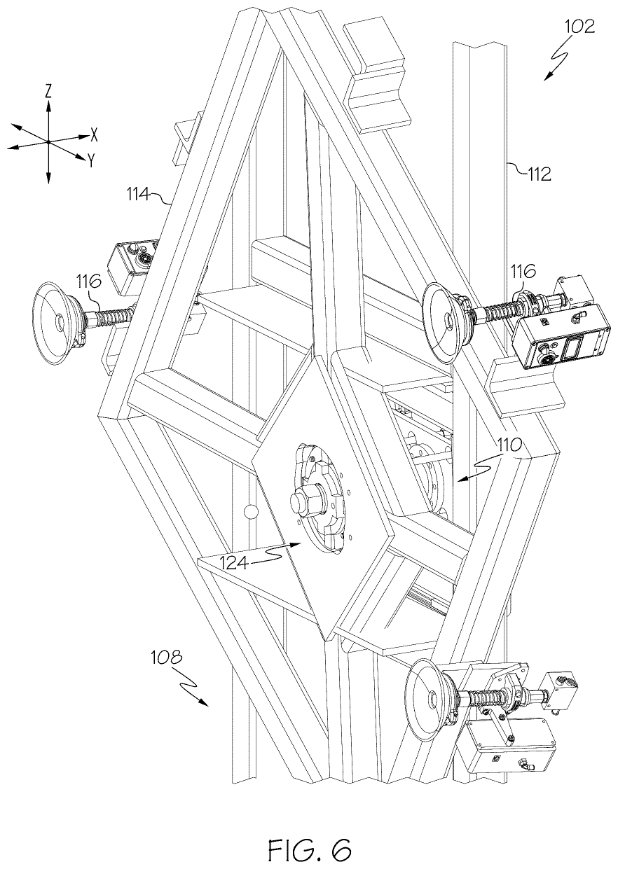

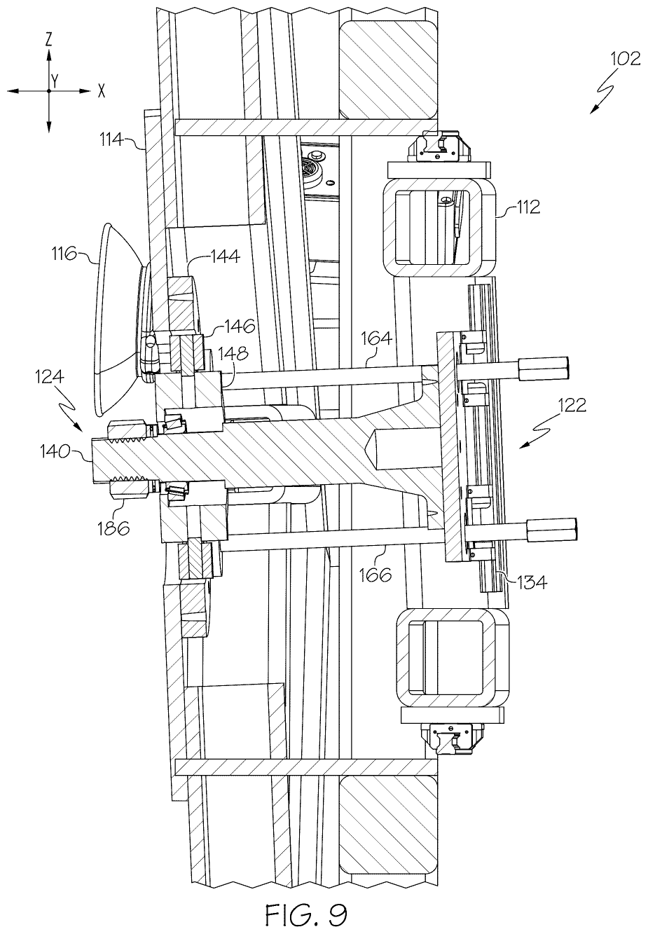

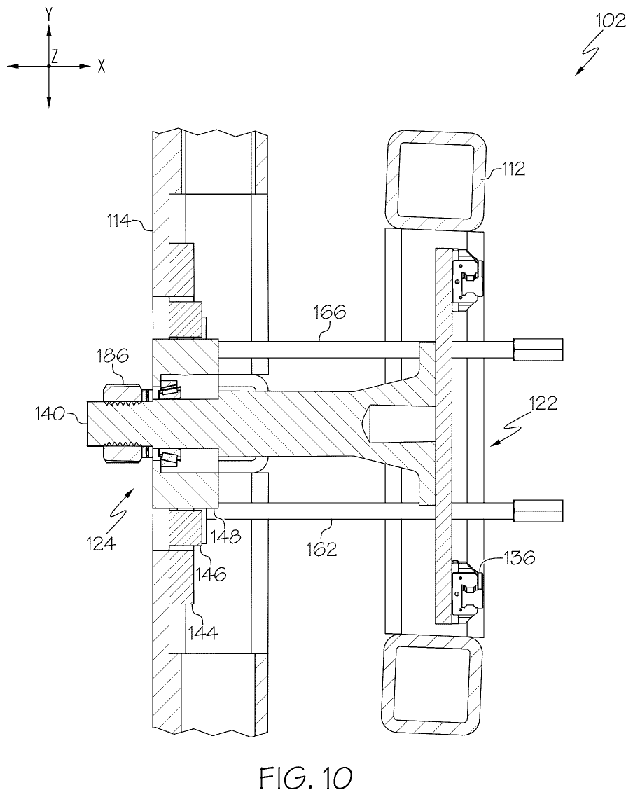

Referring generally to FIGS. 1-12, by way of examples, the present disclosure is directed to an apparatus 102, a system 100, and a method 1000 for manipulating a panel structure. Generally, examples of the apparatus 102, system 100, and method 1000 may be used to support, locate, and/or orient any panel-type component during manufacture and/or assembly. More particularly, examples of the apparatus 102, system 100, and method 1000 facilitate precision alignment of various types of panel structures (referred to herein as panel 104), such as skin panels of an aircraft, during determinant assembly to couple the panel to its underlying substructure (referred to herein as structure 206).

As will be described in more detail herein, examples of apparatus 102, system 100, and method 1000 address manipulation and alignment challenges associated with determinant assembly by providing a frame assembly that supports a panel structure, a linear displacement device that enables linear displacement of the supported panel structure along three orthogonal axes, and an angular displacement device that enables axial rotation of the supported panel structure about three orthogonal axes to provide six degrees of freedom (6 DOF) of movement of a large panel secured to the frame assembly. Examples of the apparatus 102, system 100, and method 1000 incorporate a dynamically manageable gimbal to adjust the panel about 3 axes and linear rails to adjust the panel along 3 axes. This approach creates an infinitely adjustable panel, such that the panel can mate to all substructure components with determinant assembly required precision.

Referring now to FIGS. 1 and 3-12, the following are examples of the apparatus 102, according to the present disclosure. The apparatus 102 includes a number of elements, features, and components. Not all of the elements, features, and/or components described or illustrated in one example are required in that example. Some or all of the elements, features, and/or components described or illustrated in one example can be combined with other examples in various ways without the need to include other elements, features, and/or components described in those other examples, even though such combination or combinations are not explicitly described or illustrated by example herein.

Referring to FIG. 1, as will be described in more detail herein, in various examples, the apparatus 102 includes a number or combination of components, including one or more of a frame assembly 108, a supporting frame 112, an orienting frame 114, a plurality of grippers 116, a joint assembly 110, a linear displacement joint 122, an angular displacement joint 124, a brake assembly 118, a linear brake assembly 126, an X-axis linear brake 192, a Y-axis linear brake 194, a Z-axis linear brake 196, an angular brake assembly 128, an X-axis rail assembly 132, a Y-axis rail assembly 134, a Z-axis rail assembly 136, a support shaft 140, a gimbal 142, a mounting frame 144, an outer gimbal 146, an inner gimbal 148, a Y-axis angular brake 152, a Z-axis angular brake 154, a first Y-axis brake 162, a second Y-axis brake 164, a first Z-axis brake 166, a second Z-axis brake 168, a counterweight 172, vacuum grippers 174, mechanical grippers 176, and magnetic grippers 178.

Referring to FIGS. 1, 3, 4, 11 and 12, in one or more examples, the apparatus 102 includes the frame assembly 108. The frame assembly 108 is configured to be temporarily coupled to the panel 104 and enables the apparatus 102 to support, manipulate, and transport the panel 104 during an assembly operation (e.g., determinant assembly). In one or more examples, the frame assembly 108 includes the supporting frame 112 and the orienting frame 114. In one or more examples, the frame assembly 108 includes the joint assembly 110. The joint assembly 110 couples the supporting frame 112 and the orienting frame 114 together and enables translation along at least one axis and/or rotation about at least one axis of the orienting frame 114 relative to the supporting frame 112. In one or more examples, the frame assembly 108 includes the brake assembly 118. The brake assembly 118 is configured to selectively inhibit translation along at least one axis and/or rotation about at least one axis of the orienting frame 114 relative to the supporting frame 112. In other examples, the frame assembly 108 can include various other components.

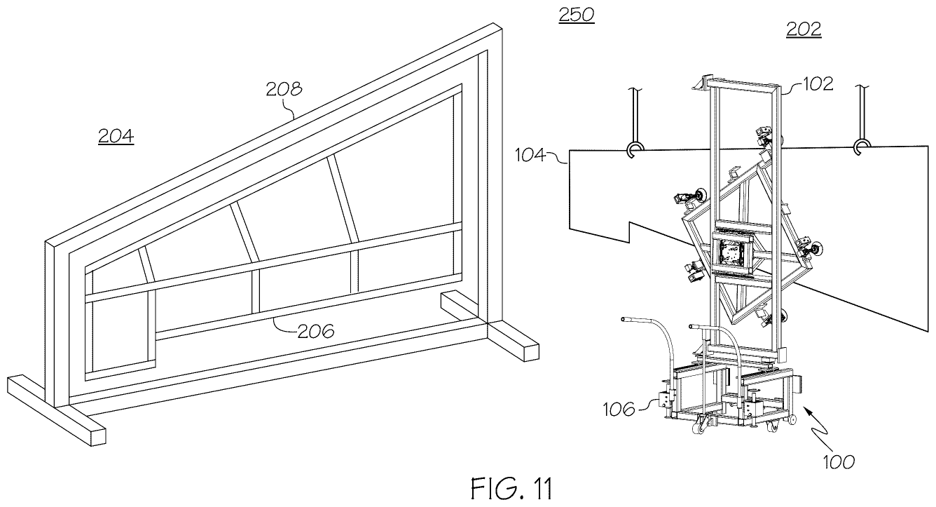

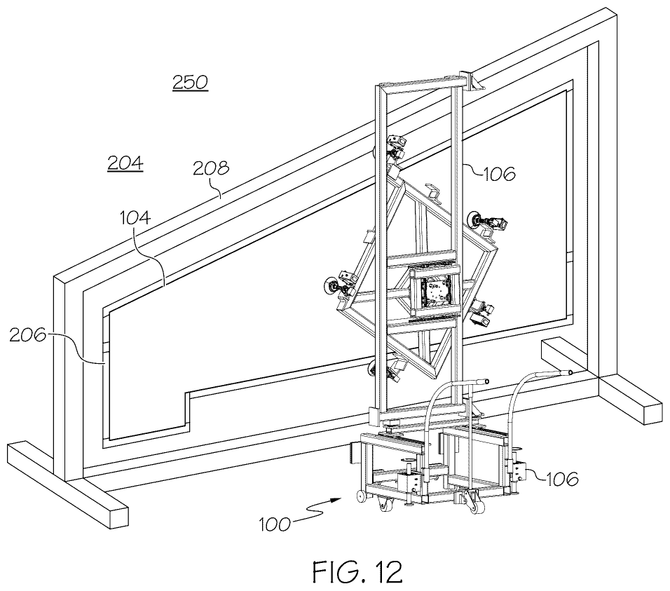

In one or more examples, the supporting frame 112 provides underlying structural support for the orienting frame 114. In various examples, the supporting frame 112 is generally oriented vertically or stands upright. However, in other examples, the supporting frame 112 can have other configurations. The supporting frame 112 includes any number of frame sections, made out of any suitable material and in any suitable structural configuration. In one or more examples, the supporting frame 112 enables the orienting frame 114, and the panel 104 coupled to the orienting frame 114, to be transported within a manufacturing environment 250 (FIGS. 11 and 12), such as via a suitable mobile platform.

In one or more examples, the orienting frame 114 is coupled to the supporting frame 112. In one or more examples, the orienting frame 114 is movable in at least five degrees of freedom relative to the supporting frame 112. In one or more examples, the orienting frame 114 is movable in six degrees of freedom relative to the supporting frame 112. Movement of the orienting frame 114 relative to the supporting frame 112 enables free movement and manipulation of the panel 104, coupled to the orienting frame 114, in three-dimensional space.

In one or more examples, the orienting frame 114 provides underlying structural support for the panel 104. In various examples, the orienting frame 114 is generally oriented vertically or stands upright. However, in other examples, the orienting frame 114 can have other configurations. The orienting frame 114 includes any number of frame sections, made out of any suitable material and in any suitable structural configuration. In one or more examples, the orienting frame 114 enables the panel 104, coupled to the orienting frame 114, to be held and manipulated the manufacturing environment 250.

In one or more examples, the grippers 116 are coupled to the orienting frame 114. The grippers 116 are configured or adapted to be selectively coupled to and released (or de-coupled) from the panel 104. The grippers 116 include any suitable type or configuration suitable to securely grasp the panel 104 of different shapes, sizes, and materials. Generally, each one of the grippers 116 includes a number of operational components, such as a housing, at least one actuator mechanism, and at least one gripping element. The actuator mechanism is configured to enable controlled movement of the gripping element relative to the housing and/or facilitate the grasping and manipulation of the panel 104. In various examples, the grippers 116 can include mechanical grippers, pneumatic grippers, and the like.

Generally, the grippers 116 refer to or include any suitable type, style, or implementation of gripping, grasping, clamping, fastening, or holding mechanisms configured to be temporarily or releasably coupled to a panel structure for the purpose of retaining and supporting the panel structure. In one or more examples, the grippers 116 include or take the form of vacuum grippers 174. In one or more examples, the grippers 116 include or take the form of mechanical grippers 176. In one or more examples, the grippers 116 include or take the form of magnetic grippers 178. Another example of the grippers 116 includes electrostatic grippers. Another example of the grippers 116 includes thru-hole fasteners. The type or style of gripper can be selected based on the versatility, reliability, efficiency, and adaptability requirements of the grippers and is not intended to be structurally or functionally limited to any particular mechanism or device.

In one or more examples, the grippers 116 are spaced apart or otherwise distributed at various locations relative to the orienting frame 114 and to one another. As an example, at least one of the grippers 116 is coupled to one of the frame sections of the orienting frame 114. In one or more examples, the grippers 116 are movable relative to the orienting frame 114. As an example, the grippers 116 are movable along an associated one of the frame sections of the orienting frame 114. In these examples, the grippers 116 can be moved manually, for example, using clamps, pins, rails, and the like, or automatically, for example, using motors, motion controllers, and the like. Movement of the grippers 116 relative to the orienting frame 114 enables the grippers 116 to be selectively positioned relative to the panel 104 for proper engagement with the panel 104 of different shapes, sizes, and materials. Selective positioning of the grippers 116 also enables the apparatus 102 to accommodate for the center of gravity of the panel 104.

Referring to FIGS. 1, 3, 5, 7, 9 and 10, in one or more examples, the apparatus 102 includes the linear displacement joint 122. In one or more examples, the linear displacement joint 122 is an example of or forms a portion of the joint assembly 110. The linear displacement joint 122 is coupled to the supporting frame 112 and the orienting frame 114. As an example, the linear displacement joint 122 couples the orienting frame 114 to the supporting frame 112. In one or more examples, the linear displacement joint 122 enables translation of the orienting frame 114 relative to the supporting frame 112 along at least one of an X-axis, a Y-axis, and a Z-axis. In one or more examples, the linear displacement joint 122 enables translation of the orienting frame 114 relative to the supporting frame 112 along each one of the X-axis, the Y-axis, and the Z-axis. Translation of the orienting frame 114 relative to the supporting frame 112 thereby enables translation of the panel 104, coupled to the orienting frame 114, relative to the structure 206 (FIGS. 11 and 12) along at least one of the X-axis, the Y-axis, and the Z-axis during alignment and installation of the panel 104. Selective translation of the orienting frame 114 relative to the supporting frame 112 along at least one of the X-axis, the Y-axis, and the Z-axis thereby enables selective translation of the panel 104 relative to the structure 206 along at least one of the X-axis, the Y-axis, and the Z-axis, such as to achieve proper alignment.

In one or more examples, the apparatus 102 includes the linear brake assembly 126. In one or more examples, the linear brake assembly 126 is an example of or forms a portion of the brake assembly 118. In these examples, the linear brake assembly 126 is configured to inhibit translation of the orienting frame 114 relative to the supporting frame 112 along at least one of the X-axis, the Y-axis, and the Z-axis. In some examples, the linear brake assembly 126 is configured to inhibit translation of the orienting frame 114 relative to the supporting frame 112 along each one of the X-axis, the Y-axis, and the Z-axis.

In one or more examples, the linear displacement joint 122 includes at least one of the X-axis rail assembly 132, the Y-axis rail assembly 134, and the Z-axis rail assembly 136. In other examples, the linear displacement joint 122 includes each one of the X-axis rail assembly 132, the Y-axis rail assembly 134, and the Z-axis rail assembly 136.

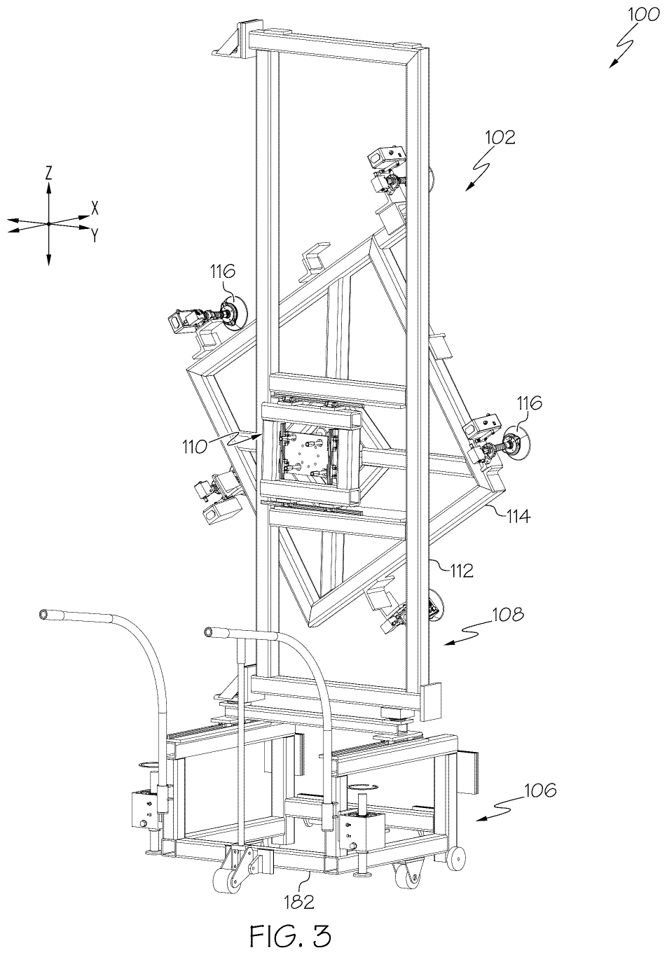

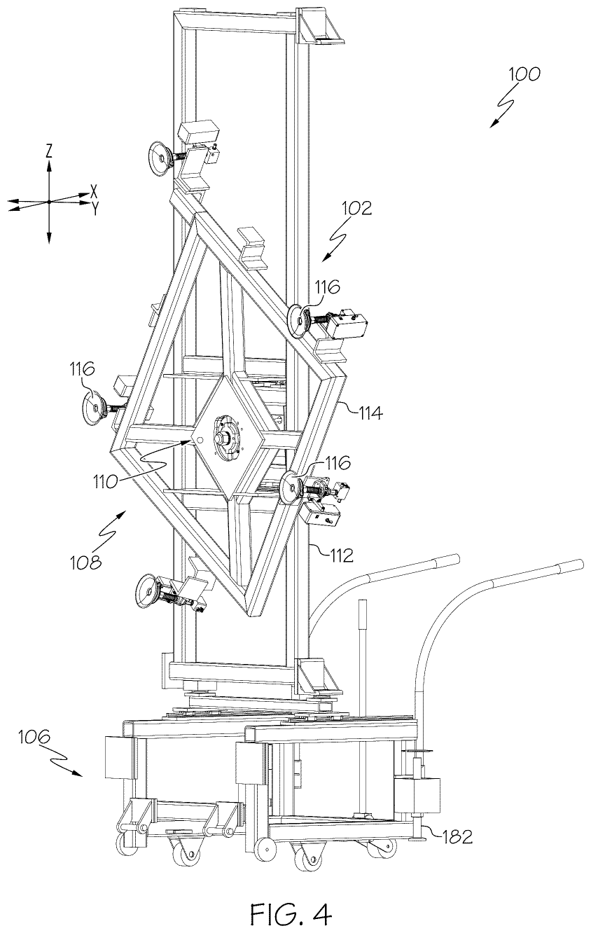

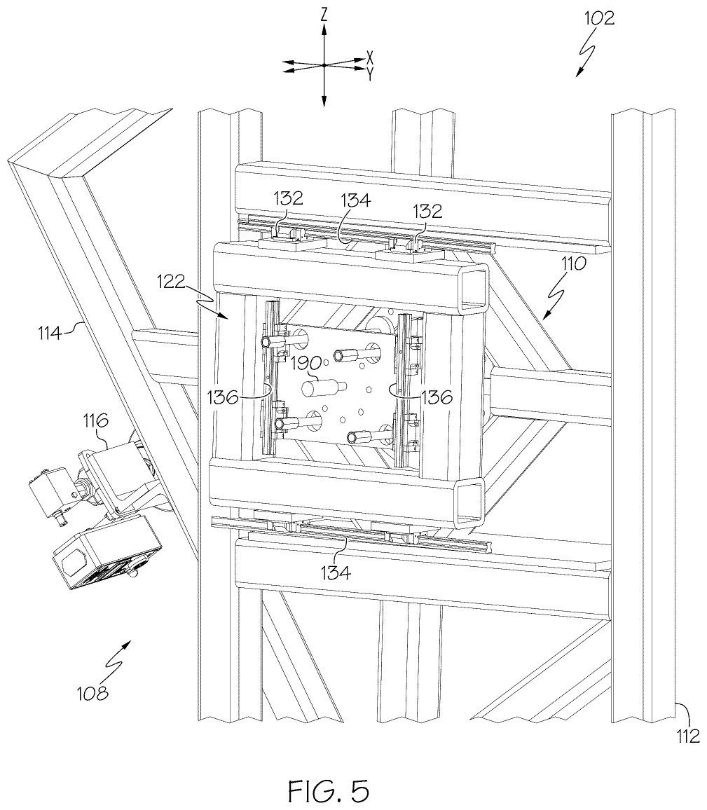

In one or more examples, the X-axis rail assembly 132 is configured to enable translation of the panel 104, coupled to the orienting frame 114, along the X-axis relative to the structure 206. In one or more examples, as illustrated in FIGS. 3 and 4, the X-axis rail assembly 132 is coupled to the supporting frame 112 and a mobile platform 106. As an example, the X-axis rail assembly 132 couples the supporting frame 112 to the mobile platform 106. In these examples, the X-axis rail assembly 132 is configured to enable translation of the supporting frame 112, and the orienting frame 114 coupled to the supporting frame 112 and the panel 104 coupled to the orienting frame 114, along the X-axis relative to the mobile platform 106. In one or more examples, as illustrated in FIG. 5, the X-axis rail assembly 132 is coupled to the supporting frame 112 and the orienting frame 114. As an example, the X-axis rail assembly 132 couples the orienting frame 114 to the supporting frame 112. In these examples, the X-axis rail assembly 132 is configured to enable translation of the orienting frame 114, and the panel 104 coupled to the orienting frame 114, along the X-axis relative to the supporting frame 112. In other examples, the apparatus 102 includes both example instances of the X-axis rail assembly 132. In these examples, the first instance of the X-axis rail assembly 132, coupling the supporting frame 112 and the mobile platform 106, enables gross or large magnitude movements along the X-axis and the second instance of the X-axis rail assembly 132, coupling the orienting frame 114 and the supporting frame 112, enables fine or smaller magnitude movements along the X-axis.

In one or more examples, the Y-axis rail assembly 134 is configured to enable translation of the panel 104, coupled to the orienting frame 114, along the Y-axis relative to the structure 206. In one or more examples, the Y-axis rail assembly 134 is coupled to the supporting frame 112 and the orienting frame 114. As an example, the Y-axis rail assembly 134 couples the orienting frame 114 to the supporting frame 112. In these examples, the Y-axis rail assembly 134 is configured to enable translation of the orienting frame 114, and the panel 104 coupled to the orienting frame 114, along the Y-axis relative to the supporting frame 112.

In one or more examples, the Z-axis rail assembly 136 is configured to enable translation of the panel 104, coupled to the orienting frame 114, along the Z-axis relative to the structure 206. In one or more examples, the Z-axis rail assembly 136 is coupled to the supporting frame 112 and the orienting frame 114. As an example, the Z-axis rail assembly 136 couples the orienting frame 114 to the supporting frame 112. In these examples, the Z-axis rail assembly 136 is configured to enable translation of the orienting frame 114, and the panel 104 coupled to the orienting frame 114, along the Z-axis relative to the supporting frame 112.

In one or more examples, the X-axis rail assembly 132, the Y-axis rail assembly 134, and/or the Z-axis rail assembly 136 include a number of components designed to support and guide the movement along a fixed path and/or expected for rail mechanisms of this type, including, but not limited to, rails, tracks, bearings, rollers, wheels, brackets, frames, and the like. In some examples, the X-axis rail assembly 132, the Y-axis rail assembly 134, and/or the Z-axis rail assembly 136 also include a drive system configured to provide motion along the rails. In one or more examples, the X-axis rail assembly 132, the Y-axis rail assembly 134, and/or the Z-axis rail assembly 136 are operated manually and, for examples, include a manual drive system, such as a manually operated drive screw and the like. In other examples, the X-axis rail assembly 132, the Y-axis rail assembly 134, and/or the Z-axis rail assembly 136 are operated automatically and, for examples, include an automatic or controllable drive system, such as an electric motor, a pneumatic actuator, a hydraulic cylinder, and the like.

Referring to FIG. 1, in one or more examples, the apparatus 102, such as the linear brake assembly 126, includes at least one of the X-axis linear brake 192, the Y-axis linear brake 194, and the Z-axis linear brake 196. An example of the linear brake assembly 126, such as at least one of the X-axis linear brake 192, the Y-axis linear brake 194, and the Z-axis linear brake 196, includes a friction brake attached to linear rails. Another example of the linear brake assembly 126, such as at least one of the X-axis linear brake 192, the Y-axis linear brake 194, and the Z-axis linear brake 196, includes a collet-based clamp attached to a shaft or rails.

In one or more examples, the linear displacement joint 122 and/or the linear brake assembly 126 includes a translation control mechanism or device configured to restrict movement along at least one of the axes and/or to support and hold the orienting frame 114 at a desired position along at least one of the axes relative to the supporting frame 112. As an example, the Z-axis rail assembly 136 and/or the Z-axis linear brake 196 is configured to inhibit, restrict, or prevent movement of the orienting frame 114 along the Z-axis in response to gravity and, thereby, holds the orienting frame 114 at a desired location along the Z-axis relative to the supporting frame 112 (e.g., prevents the orienting frame 114 and the panel 104 attached to the orienting frame 114 from just falling when released by an operator). For example, the Z-axis rail assembly 134 and/or the Z-axis linear brake 196 can include a jack screw or similar translation control mechanism. While one skilled in the art will appreciate that translation control along the Z-axis is important for managing movement and positioning of the panel 104 due to gravity, similar position control mechanisms or devices can also be incorporated into the X-axis rail assembly 132 and/or the X-axis linear brake 192 and/or the Y-axis rail assembly 134 and/or the Y-axis linear brake 194. Similarly, the angular displacement joint 124 and/or the angular brake assembly 128 can include a rotation control mechanism or device configured to restrict movement about at least one of the axes and/or to support and hold the orienting frame 114 at a desired orientation about at least one of the axes relative to the supporting frame 112. Another example for preventing unwanted movement of the orienting frame 114 relative to the supporting frame 112 is in the form of zero-backlash components. These types of components remove play, slop, clearance, lash, etc. between components (e.g., by preloading components and creating friction), for example, such that the translation control mechanism and/or rotation control mechanism (e.g., lead screw of a jack screw) does not unwind by gravity alone when moving and/or oriented in the Z-axis.

Referring to FIGS. 1, 4 and 6-10, in one or mor examples, the apparatus 102 includes the angular displacement joint 124. In one or more examples, the angular displacement joint 124 is an example of or forms a portion of the joint assembly 110. The angular displacement joint 124 is coupled to the supporting frame 112 and the orienting frame 114. As an example, the angular displacement joint 124 couples the orienting frame 114 to the supporting frame 112. In one or more examples, the angular displacement joint 124 enables rotation of the orienting frame 114 relative to the supporting frame 112 about at least one of the X-axis, the Y-axis, and the Z-axis. In one or more examples, the angular displacement joint 124 enables rotation of the orienting frame 114 relative to the supporting frame 112 about each one of the X-axis, the Y-axis, and the Z-axis. Rotation of the orienting frame 114 relative to the supporting frame 112 thereby enables rotation of the panel 104, coupled to the orienting frame 114, relative to the structure 206 (FIGS. 11 and 12) about at least one of the X-axis, the Y-axis, and the Z-axis during alignment and installation of the panel 104. Selective rotation of the orienting frame 114 relative to the supporting frame 112 about at least one of the X-axis, the Y-axis, and the Z-axis thereby enables selective rotation of the panel 104 relative to the structure 206 about at least one of the X-axis, the Y-axis, and the Z-axis, such as to achieve proper alignment.

In one or more examples, the apparatus 102 includes the angular brake assembly 128. In one or more examples, the angular brake assembly 128 is an example of or forms a portion of the brake assembly 118. In these examples, the angular brake assembly 128 is configured to inhibit rotation of the orienting frame 114 relative to the supporting frame 112 about at least one of the Y-axis and the Z-axis. In some examples, the angular brake assembly 128 is configured to inhibit rotation of the orienting frame 114 relative to the supporting frame 112 about each one of the Y-axis and the Z-axis. Selectively inhibiting rotation of the orienting frame 114 relative to the supporting frame 112 about at least one of the Y-axis and the Z-axis thereby enables selectively inhibiting rotation of the panel 104 relative to the structure 206 along at least one of the Y-axis and the Z-axis, such as when proper alignment is achieved.

Referring to FIG. 5, in one or more examples, the apparatus 102 includes a handle 190, such as a knob or other manual manipulation device. The handle 190 is configured to enable motion control over translation and/or rotation of the orienting frame 114 relative to the supporting frame 112. As an example, the handle 190 includes a conical type “pin” to engage a coned recess. When fully engaged, the orienting frame 114 cannot rotate about the X-axis. When there is a gap between the conical pin and the coned recess, it allows a determined amount of rotation about the X-axis.

In one or more examples, the apparatus 102 includes the linear displacement joint 122, which is coupled to the supporting frame 112, and the angular displacement joint 124, which is coupled to the linear displacement joint 122 and the orienting frame 114. The linear displacement joint 122 enables translation of the orienting frame 114 relative to the supporting frame 112 along the X-axis, the Y-axis, and the Z-axis. The angular displacement joint 124 enables rotation of the orienting frame 114 relative to the supporting frame 112 about the X-axis, the Y-axis, and the Z-axis. The apparatus 102 also includes the linear brake assembly 126 and the angular brake assembly 128. The linear brake assembly 126 is configured to inhibit translation of the orienting frame 114 relative to the supporting frame 112 along the X-axis, the Y-axis, and the Z-axis. The angular brake assembly 128 is configured to inhibit rotation of the orienting frame 114 relative to the supporting frame 112 about the Y-axis and the Z-axis.

Referring to FIGS. 1 and 7-10, in one or more examples, the angular displacement joint 124 includes the support shaft 140 and the gimbal 142. In these examples, the support shaft 140 is coupled to the supporting frame 112. The gimbal 142 is coupled to the support shaft 140 and the orienting frame 114. In these examples, a centerline of the support shaft 140 defines a first rotational axis (X-axis). The gimbal 142 is configured to rotate about a first rotational axis relative to the support shaft 140. The gimbal 142 defines the second rotational axis (Y-axis) and the third rotational axis (Z-axis). Thus, in these examples, the support shaft 140 enables rotation of the orienting frame 114, and the panel 104 coupled to the orienting frame 114, about the X-axis relative to the supporting frame 112 and the gimbal 142 enables rotation of the orienting frame 114, and the panel 104 coupled to the orienting frame 114, about the Y-axis and the Z-axis relative to the supporting frame 112.

In one or more examples, the gimbal 142 includes or takes the form of any suitable mechanical device including rings or pivots mounted in such a way that the orienting frame 114 can rotate freely in all three axes (pitch, yaw, and roll). The primary purpose of the gimbal 142 is to maintain the orientation of the orienting frame 114 regardless of the motion of the platform (e.g., supporting frame 112 or mobile platform 106) it is mounted on and to enable selective orientation of the orienting frame 114. The gimbal 142 includes three axes of rotation, including a Pitch Axis (e.g., Y-axis) that controls up-and-down movement (tilting), a Yaw Axis (e.g., Z-axis) that controls left-and-right movement (panning), and a Roll Axis (e.g., X-axis) that controls side-to-side movement (rolling).

In one or more examples, the gimbal 142 includes the mounting frame 144, the outer gimbal 146, and the inner gimbal 148. The mounting frame 144 is coupled to the orienting frame 114. The outer gimbal 146 is coupled to the mounting frame 144. The outer gimbal 146 is configured to rotate about the Y-axis relative to the mounting frame 144. The inner gimbal 148 is coupled to the outer gimbal 146 and the support shaft 140. The inner gimbal 148 is configured to rotate about the Z-axis relative to the outer gimbal 146. The inner gimbal 148 is configured to rotate about the X-axis relative to the support shaft 140.

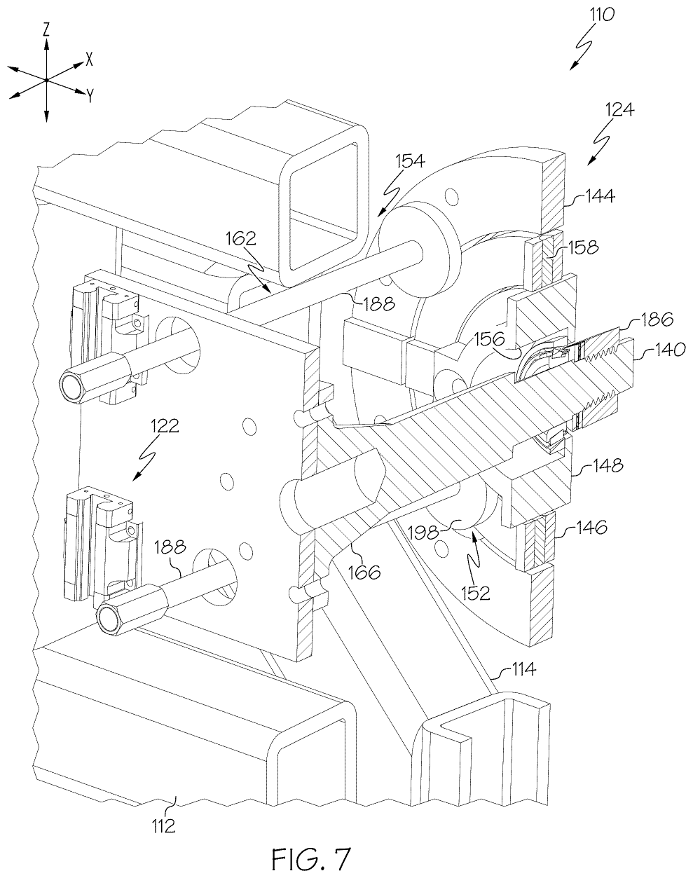

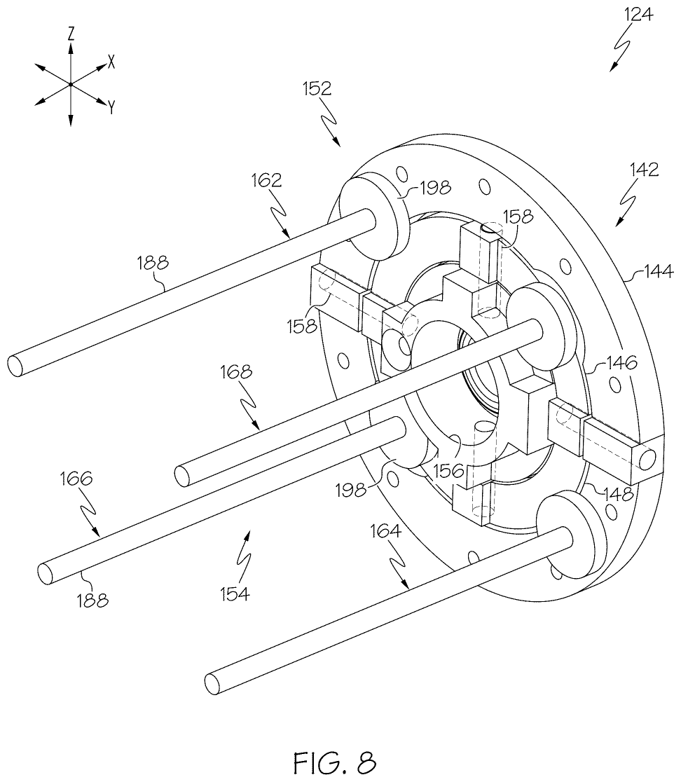

In one or more examples, as illustrated in FIGS. 7 and 8, each one of the mounting frame 144, the outer gimbal 146, and the inner gimbal 148 includes or takes the form of a ring structure or other annular element and are situated in a concentric configuration relative to one another. In one or more examples, the outer gimbal 146 is coupled to the mounting frame 144 via a first pair of pins 158 situated along or otherwise defining one axis of rotation (e.g., one degree of freedom) of the gimbal 142, such as the Y-axis in FIGS. 7 and 8. In one or more examples, the inner gimbal 148 is coupled to the outer gimbal 146 via a second pair of the pins 158 situated along or otherwise defining one axis of rotation (e.g., one degree of freedom) of the gimbal 142, such as the Z-axis in FIGS. 7 and 8.

While not explicitly illustrated, in other examples, the relative rotational configuration of the components of the gimbal 142 and/or the corresponding axis of rotation associated with each of the components of the gimbal 142 can be different (e.g., reversed) as compared to the illustrative examples. For example, the outer gimbal 146 is configured to rotate about the Z-axis relative to the mounting frame 144 and the inner gimbal 148 is configured to rotate about the Y-axis relative to the outer gimbal 146.

Referring to FIGS. 1, 7, 9 and 10, in one or more examples, the apparatus 102 includes the rotary bearing 186. In these examples, the rotary bearing 186 is disposed between the inner gimbal 148 and the support shaft 140. The rotary bearing 186 reduces friction and facilitates connection of the inner gimbal 148 to the support shaft 140 and rotation of the inner gimbal 148 about the support shaft 140. In one or more examples, the inner gimbal 148 includes a center aperture 156 configured to concentrically receive a portion of the rotary bearing 186. The rotary bearing 186 is concentrically coupled to an end of the support shaft 140.

Referring to FIGS. 1 and 7-10, in one or more examples, the apparatus 102, such as the angular brake assembly 128, includes at least one of the Y-axis angular brake 152 and the Z-axis angular brake 154. In one or more examples, the apparatus 102, such as the angular brake assembly 128, includes each one of the Y-axis angular brake 152 and the Z-axis angular brake 154.

In one or more examples, the Y-axis angular brake 152 is configured to inhibit rotation of the outer gimbal 146 about the Y-axis relative to the mounting frame 144. In one or more examples, the Y-axis angular brake 152 is configured to selectively inhibit rotation of the outer gimbal 146 relative to the mounting frame 144 in at least one rotational direction about the Y-axis. In one or more examples, the Y-axis angular brake 152 is configured to selectively inhibit rotation of the outer gimbal 146 relative to the mounting frame 144 in opposing rotational directions about the Y-axis.

In one or more examples, the Z-axis angular brake 154 is configured to inhibit rotation of the inner gimbal 148 about the Z-axis relative to the outer gimbal 146. In one or more examples, the Z-axis angular brake 154 is configured to selectively inhibit rotation of the inner gimbal 148 relative to the outer gimbal 146 in at least one rotational direction about the Z-axis. In one or more examples, the Z-axis angular brake 154 is configured to selectively inhibit rotation of the inner gimbal 148 relative to the outer gimbal 146 in opposing rotational directions about the Z-axis.

In one or more examples, the Y-axis angular brake 152 includes the first Y-axis brake 162 and the second Y-axis brake 164. In these examples, the first Y-axis brake 162 and the second Y-axis brake 164, in combination, are configured to selectively inhibit rotation of the outer gimbal 146 about the Y-axis.

In one or more examples, the first Y-axis brake 162 is configured to selectively inhibit rotation of the outer gimbal 146 in a first rotational direction about the Y-axis relative to the mounting frame 144. As an example, the first Y-axis brake 162 is configured to selectively (e.g., movably) engage the mounting frame 144 and the outer gimbal 146 to inhibit rotation of the outer gimbal 146 relative to the mounting frame 144 in the first rotational direction about the Y-axis. The first Y-axis brake 162 is configured to selectively (e.g., movably) disengage the mounting frame 144 and the outer gimbal 146 to enable rotation of the outer gimbal 146 relative to the mounting frame 144 in the first rotational direction about the Y-axis.

In one or more examples, the second Y-axis brake 164 is configured to selectively inhibit rotation of the outer gimbal 146 in a second rotational direction about the Y-axis relative to the mounting frame 144. In these examples, the second rotational direction is opposite the first rotational direction. As an example, the second Y-axis brake 164 is configured to selectively (e.g., movably) engage the mounting frame 144 and the outer gimbal 146 to inhibit rotation of the outer gimbal 146 relative to the mounting frame 144 in the second rotational direction about the Y-axis. The second Y-axis brake 164 is configured to selectively (e.g., movably) disengage the mounting frame 144 and the outer gimbal 146 to enable rotation of the outer gimbal 146 relative to the mounting frame 144 in the second rotational direction about the Y-axis.

In one or more examples, the Z-axis angular brake 154 includes the first Z-axis brake 166 and the second Z-axis brake 168. In these examples, the first Z-axis brake 166 and the second Z-axis brake 168, in combination, are configured to selectively inhibit rotation of the inner gimbal 148 about the Z-axis.

In one or more examples, the first Z-axis brake 166 is configured to selectively inhibit rotation of the inner gimbal 148 in a first rotational direction about the Z-axis relative to the outer gimbal 146. As an example, the first Z-axis brake 166 is configured to selectively (e.g., movably) engage the outer gimbal 146 and the inner gimbal 148 to inhibit rotation of the inner gimbal 148 relative to the outer gimbal 146 in a first rotational direction about the Z-axis. The first Z-axis brake 166 is configured to selectively (e.g., movably) disengage the outer gimbal 146 and the inner gimbal 148 to enable rotation of the inner gimbal 148 relative to the outer gimbal 146 in the first rotational direction about the Z-axis.

In one or more examples, the second Z-axis brake 168 is configured to selectively inhibit rotation of the inner gimbal 148 in a second rotational direction about the Z-axis relative to the outer gimbal 146. In these examples, the second rotational direction is opposite the first rotational direction. As an example, the second Z-axis brake 168 is configured to selectively (e.g., movably) engage the outer gimbal 146 and the inner gimbal 148 to inhibit rotation of the inner gimbal 148 relative to the outer gimbal 146 in a second rotational direction about the Z-axis. The second Z-axis brake 168 is configured to selectively (e.g., movably) disengage the outer gimbal 146 and the inner gimbal 148 to enable rotation of the inner gimbal 148 relative to the outer gimbal 146 in the second rotational direction about the Z-axis.

In one or more examples, as best illustrated in FIGS. 7 and 8, each one of the first Y-axis brake 162, the second Y-axis brake 164, the first Z-axis brake 166, and the second Z-axis brake 168 includes a shaft 188 and a contact element 198 coupled to an end of the shaft 188. The shaft 188 enables actuation of the brake, such as extension or inward movement of the contact element 198 toward and into contact with the gimbal 142 and retraction or outward movement of the contact element 198 away from and out of contact with the gimbal 142.

While not explicitly illustrated, in other examples, the relative rotational inhibition of the components of the angular brake assembly 128 and/or the corresponding axis of rotation associated with each of the components of the angular brake assembly 128 can be different (e.g., reversed) as compared to the illustrative examples. For example, the Z-axis angular brake 154 is configured to inhibit rotation of the outer gimbal 146 about the Z-axis relative to the mounting frame 144 and the Y-axis angular brake 152 is configured to inhibit rotation of the inner gimbal 148 about the Y-axis relative to the outer gimbal 146. In these examples, the first Z-axis brake 166 and the second Z-axis brake 168, in combination, are configured to selectively engage the mounting frame 144 and the outer gimbal 146 and selectively inhibit rotation of the outer gimbal 146 about the Z-axis and the first Y-axis brake 162 and the second Y-axis brake 164, in combination, are configured to selectively engage the outer gimbal 146 and the inner gimbal 148 and selectively inhibit rotation of the inner gimbal 148 about the Y-axis.

For the purpose of the present disclosure, the term “brake” refers to a mechanism or device that modulates and/or controls translational motion along and/or rotational motion about a given axis of motion. For example, the brake can include any mechanical, pneumatic, or hydraulic device used to slow down or stop motion of a component.

Referring to FIG. 1, in one or more examples, the apparatus 102 includes at least one counterweight 172. In these examples, the counterweight 172 is coupled to the orienting frame 114. The counterweight 172 is selected and positioned to counterbalance or offset weight imbalances of the panel 104 and/or otherwise accommodate for the center of gravity of the panel 104.

Referring now to FIGS. 1 and 3-12, the following are examples of the system 100, according to the present disclosure. The system 100 includes a number of elements, features, and components. Not all of the elements, features, and/or components described or illustrated in one example are required in that example. Some or all of the elements, features, and/or components described or illustrated in one example can be combined with other examples in various ways without the need to include other elements, features, and/or components described in those other examples, even though such combination or combinations are not explicitly described or illustrated by example herein.

Referring to FIG. 1, as described herein, in various examples, the system 100 includes a number or combination of components, including one or more of the mobile platform 106, a cart 182, an overhead gantry 184, the frame assembly 108, the supporting frame 112, the orienting frame 114, the plurality of grippers 116, the joint assembly 110, the linear displacement joint 122, the angular displacement joint 124, the brake assembly 118, the linear brake assembly 126, the x-axis linear brake 192, the Y-axis linear brake 194, the Z-axis linear brake 196, the angular brake assembly 128, the X-axis rail assembly 132, the Y-axis rail assembly 134, the Z-axis rail assembly 136, the support shaft 140, the gimbal 142, the mounting frame 144, the outer gimbal 146, the inner gimbal 148, the Y-axis angular brake 152, the Z-axis angular brake 154, the first Y-axis brake 162, the second Y-axis brake 164, the first Z-axis brake 166, the second Z-axis brake 168, the counterweight 172, the vacuum grippers 174, the mechanical grippers 176, and the magnetic grippers 178.

Referring to FIGS. 1, 3, 4, 11 and 12, in one or more examples, the system 100 includes the mobile platform 106. The supporting frame 112 is coupled to the mobile platform 106. The linear displacement joint 122 is coupled to the supporting frame 112. The angular displacement joint 124 is coupled to the linear displacement joint 122. The orienting frame 114 is coupled to the angular displacement joint 124. A plurality of the grippers 116 is coupled to the orienting frame 114. The linear displacement joint 122 enables translation of the orienting frame 114 relative to the supporting frame 112 along the X-axis, the Y-axis, and the Z-axis. The angular displacement joint 124 enables rotation of the orienting frame 114 relative to the supporting frame 112 about the X-axis, the Y-axis, and the Z-axis.

In one or more examples of the system 100, the linear brake assembly 126 is configured to inhibit translation of the orienting frame 114 relative to the supporting frame 112 along the X-axis, the Y-axis, and the Z-axis. The angular brake assembly 128 is configured to inhibit rotation of the orienting frame 114 relative to the supporting frame 112 about the Y-axis and the Z-axis.

In one or more examples of the system 100, the mobile platform 106 includes any suitable mechanism or device that enables movement of the apparatus 102 within the environment 250. In one or more examples, the mobile platform 106 includes the cart 182. In these examples, the cart 182 enables the apparatus 102 to be transported between different locations within the environment 250 (FIG. 11). In one or more examples, the apparatus 102, such as the supporting frame 112, is coupled to the cart 182. In one or more examples, the cart 182 is manually guided and propelled and includes wheels, rollers, a track, and the like. In one or more examples, the cart 182 is automatically guided and propelled and includes, for example, an automated guided vehicle (AGV). In one or more examples of the system 100, the mobile platform 106 includes the overhead gantry 184. In these examples, the overhead gantry 184 enables the apparatus 102 to be transported between different locations within the environment 250 (FIG. 11). In one or more examples, the apparatus 102, such as the supporting frame 112, is coupled to the overhead gantry 184.

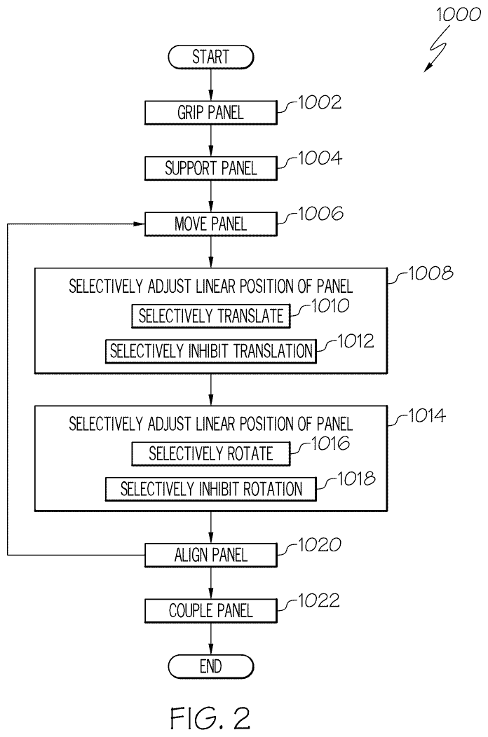

Referring now to FIG. 2, the following are examples of the method 1000, according to the present disclosure. The method 1000 includes a number of elements, steps, operations, or processes. Not all of the elements, steps, operations, or processes described or illustrated in one example are required in that example. Some or all of the elements, steps, operations, or processes described or illustrated in one example can be combined with other examples in various ways without the need to include other elements, steps, operations, or processes described in those other examples, even though such combination or combinations are not explicitly described or illustrated by example herein.

Referring generally to FIGS. 1 and 3-12 and particularly to FIG. 2, in one or more examples, the method 1000 is implemented using the system 100 or the apparatus 102. FIGS. 11 and 12 illustrate examples of the manufacturing environment 250 within which the method 1000 is implemented using the system 100.

In one or more examples, the method 1000 includes a step of, at a first location 202, gripping 1002 the panel 104 with a plurality of the grippers 116. As illustrated in FIG. 11, in one or more examples, the panel 104 is situated or presented for pick-up by the system 100. In one or more examples, the system 100 is coupled to the panel 104 using the grippers 116 proximate to the center of gravity of the panel 104.

In one or more examples, the method 1000 includes a step of supporting 1004 the panel 104. Generally, the panel 104 is supported by the frame assembly 108. More particularly, the panel 104 is held by the grippers 116. The grippers 116 are coupled to the orienting frame 114. The grippers 116, holding the panel 104, are supported by the orienting frame 114. The orienting frame 114 is coupled to the supporting frame 112. The orienting frame 114, and the grippers 116 holding the panel 104, are supported by the supporting frame 112. The supporting frame 112 is coupled to the mobile platform 106 for movement of the system 100 within the environment 250 (e.g., as shown in FIGS. 11 and 12).

In one or more examples, the method 1000 includes a step of moving 1006 the panel 104 from the first location 202 to a second location 204 (FIGS. 11 and 12). In one or more examples, the panel 104 is moved using the mobile platform 106. The supporting frame 112 is coupled to the mobile platform 106.

In one or more examples, the method 1000 includes a step of selectively adjusting 1008 a linear position of the panel 104 relative to the structure 206. In one or more examples, the linear position of the panel 104 is selectively adjusted by selectively translating 1010 the panel 104 relative to the structure 206 along at least one of the X-axis, the Y-axis, and the Z-axis. As an example, the linear position of the panel 104 is selectively adjusted selectively translating the orienting frame 114 relative to the supporting frame 112 along at least one of the X-axis, the Y-axis, and the Z-axis. In one or more examples, the linear position of the panel 104 is further selectively adjusted by selectively inhibiting 1012 translation of the panel 104 relative to the structure 206 along at least one of the X-axis, the Y-axis, and the Z-axis. As an example, the linear position of the panel 104 is further selectively adjusted by selectively inhibiting translation of the orienting frame 114 relative to the supporting frame 112 along the X-axis, the Y-axis, and the Z-axis. In these examples, the linear position of the panel 104 is selectively adjusted using the linear displacement joint 122 and the linear brake assembly 126.

In one or more examples, the method 1000 includes a step of selectively adjusting 1014 an angular position of the panel 104 relative to the structure 206. In one or more examples, the angular position of the panel 104 is selectively adjusted by selectively rotating 1016 the panel 104 relative to the structure 206 about at least one of the X-axis, the Y-axis, and the Z-axis. As an example, the angular position of the panel 104 is selectively adjusted by selectively rotating 1016 the orienting frame 114 relative to the supporting frame 112 about at least one of the X-axis, the Y-axis, and the Z-axis. In one or more examples, the angular position of the panel 104 is further selectively adjusted by selectively inhibiting 1018 rotation of the panel 104 relative to the structure 206 about at least one of the X-axis, the Y-axis, and the Z-axis. As an example, the angular position of the panel 104 is further selectively adjusted by selectively inhibiting rotation of the orienting frame 114 relative to the supporting frame 112 along the Y-axis and the Z-axis.

In one or more examples, the method 1000 also includes a step of aligning 1020 the panel 104 to the structure 206 and a step of coupling 1022 the panel 104 to the structure 206. In one or more examples, the structure 206 is supported by an assembly jig 208 or other suitable tooling. In these examples, the panel 104 is properly aligned with the structure 206 for determinant assembly according to the operational steps described above. The panel 104 is coupled to the structure 206 using any suitable determinant assembly technique, such as installing mechanical fasteners through pre-drilled and aligned holes. In one or more examples, the apparatus 102, such as the supporting frame 112, is coupled to the jig 208 for performing the alignment operations according to the method 1000.

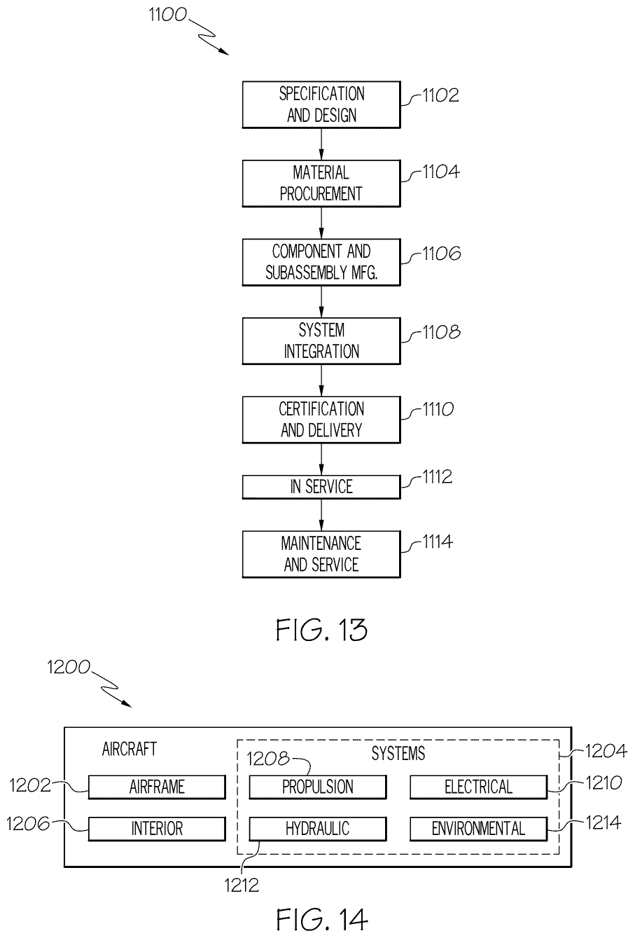

Referring now to FIGS. 13 and 14, examples of apparatus 102, system 100, and method 1000 described herein, may be related to, or used in the context of, the aerospace manufacturing and service method 1100, as shown in the flow diagram of FIG. 13 and an aircraft 1200, as schematically illustrated in FIG. 14. As an example, the aircraft 1200 and/or the manufacturing and service method 1100 may include or utilize various panels (e.g., skin panels) or other large components that are aligned and installed to an underlying substructure using the apparatus 102 or the system 100 and/or according to the method 1000.

Referring to FIG. 14, which illustrates an example of the aircraft 1200. The aircraft 1200 can be any aerospace vehicle or platform. In one or more examples, the aircraft 1200 includes the airframe 1202 having the interior 1206. The aircraft 1200 includes a plurality of onboard systems 1204 (e.g., high-level systems). Examples of the onboard systems 1204 of the aircraft 1200 include propulsion systems 1208, hydraulic systems 1212, electrical systems 1210, and environmental systems 1214. In other examples, the onboard systems 1204 also includes one or more control systems coupled to the airframe 1202 of the aircraft 1200. In yet other examples, the onboard systems 1204 also include one or more other systems, such as, but not limited to, communications systems, avionics systems, software distribution systems, network communications systems, passenger information/entertainment systems, guidance systems, radar systems, weapons systems, and the like. The aircraft 1200 can have any number of panels 104 (e.g., skin panels) or other large components that are aligned and installed to an underlying substructure using the apparatus 102 or the system 100 and/or according to the method 1000.

Referring to FIG. 13, during pre-production of the aircraft 1200, the manufacturing and service method 1100 includes specification and design 1102 of the aircraft 1200 and material procurement 1104. During production of the aircraft 1200, component and subassembly manufacturing 1106 and system integration 1108 of the aircraft 1200 take place. Thereafter, the aircraft 1200 goes through certification and delivery 1110 to be placed in service 1112. Routine maintenance and service 1114 includes modification, reconfiguration, refurbishment, etc. of one or more systems of the aircraft 1200.

Each of the processes of the manufacturing and service method 1100 illustrated in FIG. 13 may be performed or carried out by a system integrator, a third party, and/or an operator (e.g., a customer). For the purposes of this description, a system integrator may include, without limitation, any number of aircraft manufacturers and major-system subcontractors; a third party may include, without limitation, any number of vendors, subcontractors, and suppliers; and an operator may be an airline, leasing company, military entity, service organization, and so on.

Examples of the apparatus 102, system 100, and method 1000, shown and described herein, may be employed during any one or more of the stages of the manufacturing and service method 1100 shown in the flow diagram illustrated by FIG. 13. In an example, various panel structures (e.g., skin panels) or other large components of the aircraft 1200 can be installed to an underlying substructure using the apparatus 102 or the system 100 and/or according to the method 1000, during a portion of component and subassembly manufacturing 1106 and/or system integration 1108. Further, various panels (e.g., skin panels) or other large components of the aircraft 1200 can be installed to an underlying substructure using the apparatus 102 or the system 100 and/or according to the method 1000 while the aircraft 1200 is in service 1112. Also, various panels (e.g., skin panels) or other large components of the aircraft 1200 can be installed to an underlying substructure using the apparatus 102 or the system 100 and/or according to the method 1000 during system integration 1108 and certification and delivery 1110. Similarly, various panels (e.g., skin panels) or other large components of the aircraft 1200 can be installed to an underlying substructure using the apparatus 102 or the system 100 and/or according to the method 1000 while the aircraft 1200 is in service 1112 and during maintenance and service 1114.

The preceding detailed description refers to the accompanying drawings, which illustrate specific examples described by the present disclosure. Other examples having different structures and operations do not depart from the scope of the present disclosure. Like reference numerals may refer to the same feature, element, or component in the different drawings. Throughout the present disclosure, any one of a plurality of items may be referred to individually as the item and a plurality of items may be referred to collectively as the items and may be referred to with like reference numerals. Moreover, as used herein, a feature, element, component, or step preceded with the word “a” or “an” should be understood as not excluding a plurality of features, elements, components, or steps, unless such exclusion is explicitly recited.

Illustrative, non-exhaustive examples, which may be, but are not necessarily, claimed, of the subject matter according to the present disclosure are provided above. Reference herein to “example” means that one or more feature, structure, element, component, characteristic, and/or operational step described in connection with the example is included in at least one aspect, embodiment, and/or implementation of the subject matter according to the present disclosure. Thus, the phrases “an example,” “another example,” “one or more examples,” and similar language throughout the present disclosure may, but do not necessarily, refer to the same example. Further, the subject matter characterizing any one example may, but does not necessarily, include the subject matter characterizing any other example. Moreover, the subject matter characterizing any one example may be, but is not necessarily, combined with the subject matter characterizing any other example.

As used herein, a system, apparatus, device, structure, article, element, component, or hardware “configured to” perform a specified function is indeed capable of performing the specified function without any alteration, rather than merely having potential to perform the specified function after further modification. In other words, the system, apparatus, device, structure, article, element, component, or hardware “configured to” perform a specified function is specifically selected, created, implemented, utilized, programmed, and/or designed for the purpose of performing the specified function. As used herein, “configured to” denotes existing characteristics of a system, apparatus, structure, article, element, component, or hardware that enable the system, apparatus, structure, article, element, component, or hardware to perform the specified function without further modification. For purposes of this disclosure, a system, apparatus, device, structure, article, element, component, or hardware described as being “configured to” perform a particular function may additionally or alternatively be described as being “adapted to” and/or as being “operative to” perform that function.

Unless otherwise indicated, the terms “first,” “second,” “third,” etc. are used herein merely as labels, and are not intended to impose ordinal, positional, or hierarchical requirements on the items to which these terms refer. Moreover, reference to, e.g., a “second” item does not require or preclude the existence of, e.g., a “first” or lower-numbered item, and/or, e.g., a “third” or higher-numbered item.

As used herein, the phrase “at least one of,” when used with a list of items, means different combinations of one or more of the listed items may be used and only one of each item in the list may be needed. For example, “at least one of item A, item B, and item C” may include, without limitation, item A or item A and item B. This example also may include item A, item B, and item C, or item B and item C. In other examples, “at least one of” may be, for example, without limitation, two of item A, one of item B, and ten of item C; four of item B and seven of item C; and other suitable combinations. As used herein, the term “and/or” and the “/” symbol includes any and all combinations of one or more of the associated listed items.

For the purpose of this disclosure, the terms “coupled,” “coupling,” and similar terms refer to two or more elements that are joined, linked, fastened, attached, connected, put in communication, or otherwise associated (e.g., mechanically, electrically, fluidly, optically, electromagnetically) with one another. In various examples, the elements may be associated directly or indirectly. As an example, element A may be directly associated with element B. As another example, element A may be indirectly associated with element B, for example, via another element C. It will be understood that not all associations among the various disclosed elements are necessarily represented. Accordingly, couplings other than those depicted in the figures may also exist.

As used herein, the term “approximately” refers to or represents a condition that is close to, but not exactly, the stated condition that still performs the desired function or achieves the desired result. As an example, the term “approximately” refers to a condition that is within an acceptable predetermined tolerance or accuracy, such as to a condition that is within 10% of the stated condition. However, the term “approximately” does not exclude a condition that is exactly the stated condition. As used herein, the term “substantially” refers to a condition that is essentially the stated condition that performs the desired function or achieves the desired result.

FIGS. 1, 3-12 and 14, referred to above, may represent functional elements, features, or components thereof and do not necessarily imply any particular structure. Accordingly, modifications, additions and/or omissions may be made to the illustrated structure. Additionally, those skilled in the art will appreciate that not all elements, features, and/or components described and illustrated in FIGS. 1, 3-12 and 14, referred to above, need be included in every example and not all elements, features, and/or components described herein are necessarily depicted in each illustrative example. Accordingly, some of the elements, features, and/or components described and illustrated in FIGS. 1, 3-12 and 14 may be combined in various ways without the need to include other features described and illustrated in FIGS. 1, 3-12 and 14, other drawing figures, and/or the accompanying disclosure, even though such combination or combinations are not explicitly illustrated herein. Similarly, additional features not limited to the examples presented, may be combined with some or all of the features shown and described herein. Unless otherwise explicitly stated, the schematic illustrations of the examples depicted in FIGS. 1, 3-12 and 14, referred to above, are not meant to imply structural limitations with respect to the illustrative example. Rather, although one illustrative structure is indicated, it is to be understood that the structure may be modified when appropriate. Accordingly, modifications, additions and/or omissions may be made to the illustrated structure. Furthermore, elements, features, and/or components that serve a similar, or at least substantially similar, purpose are labeled with like numbers in each of FIGS. 1, 3-12 and 14, and such elements, features, and/or components may not be discussed in detail herein with reference to each of FIGS. 1, 3-12 and 14. Similarly, all elements, features, and/or components may not be labeled in each of FIGS. 1, 3-12 and 14 but reference numerals associated therewith may be utilized herein for consistency.

In FIGS. 2 and 13, referred to above, the blocks may represent operations, steps, and/or portions thereof and lines connecting the various blocks do not imply any particular order or dependency of the operations or portions thereof. It will be understood that not all dependencies among the various disclosed operations are necessarily represented. FIGS. 2 and 13 and the accompanying disclosure describing the operations of the disclosed methods set forth herein should not be interpreted as necessarily determining a sequence in which the operations are to be performed. Rather, although one illustrative order is indicated, it is to be understood that the sequence of the operations may be modified when appropriate. Accordingly, modifications, additions and/or omissions may be made to the operations illustrated and certain operations may be performed in a different order or simultaneously. Additionally, those skilled in the art will appreciate that not all operations described need be performed.

Further, references throughout the present specification to features, advantages, or similar language used herein do not imply that all of the features and advantages that may be realized with the examples disclosed herein should be, or are in, any single example. Rather, language referring to the features and advantages is understood to mean that a specific feature, advantage, or characteristic described in connection with an example is included in at least one example. Thus, discussion of features, advantages, and similar language used throughout the present disclosure may, but does not necessarily, refer to the same example.

The described features, advantages, and characteristics of one example may be combined in any suitable manner in one or more other examples. One skilled in the relevant art will recognize that the examples described herein may be practiced without one or more of the specific features or advantages of a particular example. In other instances, additional features and advantages may be recognized in certain examples that may not be present in all examples. Furthermore, although various examples of the tool 100 and the method 1000 have been shown and described, modifications may occur to those skilled in the art upon reading the specification. The present application includes such modifications and is limited only by the scope of the claims.

What is claimed is:

1. An apparatus for manipulating a panel, the apparatus comprising:
a supporting frame;
an orienting frame coupled to the supporting frame and movable in six degrees of freedom relative to the supporting frame; and
a plurality of grippers coupled to the orienting frame.

2. The apparatus of claim 1, further comprising a linear displacement joint coupled to the supporting frame and the orienting frame,
wherein the linear displacement joint enables translation of the orienting frame relative to the supporting frame along an X-axis, a Y-axis, and a Z-axis.

3. The apparatus of claim 2, further comprising a linear brake assembly configured to inhibit translation of the orienting frame relative to the supporting frame along the X-axis, the Y-axis, and the Z-axis.

4. The apparatus of claim 2, wherein the linear displacement joint comprises:
an X-axis rail assembly coupled to the supporting frame and the orienting frame and configured to enable translation of the orienting frame along the X-axis relative to the supporting frame;
a Y-axis rail assembly coupled to the supporting frame and the orienting frame and configured to enable translation of the orienting frame along the Y-axis relative to the supporting frame; and
a Z-axis rail assembly coupled to the supporting frame and the orienting frame and configured to enable translation of the orienting frame along the Z-axis relative to the supporting frame.

5. The apparatus of claim 1, further comprising an angular displacement joint coupled to the supporting frame and the orienting frame,
wherein the angular displacement joint enables rotation of the orienting frame relative to the supporting frame about an X-axis, a Y-axis, and a Z-axis.

6. The apparatus of claim 5, further comprising an angular brake assembly configured to inhibit rotation of the orienting frame relative to the supporting frame about the Y-axis and the Z-axis.

7. The apparatus of claim 5, wherein the angular displacement joint comprises:
a support shaft coupled to the supporting frame; and
a gimbal coupled to the support shaft and the orienting frame.

8. The apparatus of claim 7, wherein the gimbal comprises:
a mounting frame coupled to the orienting frame;
an outer gimbal coupled to the mounting frame and configured to rotate about the Y-axis relative to the mounting frame; and
an inner gimbal coupled to the outer gimbal and the support shaft and configured to rotate about the Z-axis relative to the outer gimbal and rotate about the X-axis relative to the support shaft.

9. The apparatus of claim 8, further comprising a rotary bearing disposed between the inner gimbal and the support shaft.

10. The apparatus of claim 8, further comprising:
a Y-axis angular brake configured to inhibit rotation of the outer gimbal about the Y-axis; and
a Z-axis angular brake configured to inhibit rotation of the inner gimbal about the Z-axis.

11. The apparatus of claim 10, wherein the Y-axis angular brake comprises:
a first Y-axis brake configured to selectively engage the mounting frame and the outer gimbal to inhibit rotation of the outer gimbal in a first rotational direction about the Y-axis relative to the mounting frame; and
a second Y-axis brake configured to selectively engage the mounting frame and the outer gimbal to inhibit rotation of the outer gimbal in a second rotational direction about the Y-axis, opposite the first rotational direction, relative to the mounting frame.

12. The apparatus of claim 10, wherein the Z-axis angular brake comprises:
a first Z-axis brake configured to selectively engage the outer gimbal and the inner gimbal to inhibit rotation of the inner gimbal in a first rotational direction about the Z-axis relative to the outer gimbal; and
a second Z-axis brake configured to selectively engage the outer gimbal and the inner gimbal to inhibit rotation of the inner gimbal in a second rotational direction about the Z-axis, opposite the first rotational direction, relative to the outer gimbal.

13. The apparatus of claim 1, wherein the grippers comprise vacuum grippers.

14. The apparatus of claim 1, wherein the grippers are movable relative to the orienting frame.

15. The apparatus of claim 1, further comprising at least one counterweight coupled to the orienting frame.

16. The apparatus of claim 1, further comprising:
a linear displacement joint coupled to the supporting frame;
an angular displacement joint coupled to the linear displacement joint and the orienting frame,
wherein:
the linear displacement joint enables translation of the orienting frame relative to the supporting frame along an X-axis, a Y-axis, and a Z-axis; and
the angular displacement joint enables rotation of the orienting frame relative to the supporting frame about the X-axis, the Y-axis, and the Z-axis.

17. The apparatus of claim 16, further comprising:
a linear brake assembly configured to inhibit translation of the orienting frame relative to the supporting frame along the X-axis, the Y-axis, and the Z-axis; and
an angular brake assembly configured to inhibit rotation of the orienting frame relative to the supporting frame about the Y-axis and the Z-axis.

18. A system for manipulating a panel, the system comprising:
a mobile platform;
a supporting frame coupled to the mobile platform;
a linear displacement joint coupled to the supporting frame;
an angular displacement joint coupled to the linear displacement joint;
an orienting frame coupled to the angular displacement joint; and
a plurality of grippers coupled to the orienting frame,
wherein:
the linear displacement joint enables translation of the orienting frame relative to the supporting frame along an X-axis, a Y-axis, and a Z-axis; and
the angular displacement joint enables rotation of the orienting frame relative to the supporting frame about the X-axis, the Y-axis, and the Z-axis.

19. The system of claim 18, wherein the mobile platform comprises one of a cart or an overhead gantry.

20. A method for manipulating a panel, the method comprising:
at a first location, gripping the panel with a plurality of grippers;
supporting the panel with an orienting frame coupled to the grippers and a supporting frame coupled to the orienting frame;
moving the panel from the first location to a second location with a mobile platform coupled to the supporting frame;
selectively adjusting a linear position of the panel relative to a structure by selectively translating the orienting frame relative to the supporting frame along at least one of an X-axis, a Y-axis, and a Z-axis and selectively inhibiting translation of the orienting frame relative to the supporting frame along the X-axis, the Y-axis, and the Z-axis; and
selectively adjusting an angular position of the panel relative to the structure by selectively rotating the orienting frame relative to the supporting frame about at least one of the X-axis, the Y-axis, and the Z-axis and selectively inhibiting rotation of the orienting frame relative to the supporting frame along the Y-axis and the Z-axis.
